(19) United States
(12) Patent Application Publication
(10) Pub. No.: US 2014/0046800 A1
(43) Pub. Date: Feb. 13, 2014

(54) Smart Phone App-Based Method and System of Collecting Information for Purchasing Used Cars

(71) Applicant: Ieon C. Chen, Laguna Hills, CA (US)

(72) Inventor: Ieon C. Chen, Laguna Hills, CA (US)

(21) Appl. No.: 13/569,522

(22) Filed: Aug. 8, 2012

(51) Int. Cl. G06Q 30/06

(52) U.S. Cl. CPC G06Q 30/0623
USPC 705/26.61

(57) ABSTRACT

Provided is a system for verifying a vehicle for sale on a smart phone. The system includes a VIN decoder capable of decoding a VIN to determine the vehicle year, make, and model of the vehicle for sale. The system further includes a defect predictor and defect database configured to identify defects in vehicles having similar characteristic data to the vehicle associated with the VIN. A computer readable medium is downloadable onto the smart phone to configure the phone to communicate information corresponding to a captured image of the VIN from the vehicle to the VIN decoder. The computer readable medium further configures the smart phone to receive a signal including the characteristic data of the vehicle associated with the VIN, and defects identified by the defect predictor. The computer readable medium further configures the phone to display the received characteristic data and defects.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Technical Field of the Invention

The present invention relates to a smart phone application, and more specifically, a smart phone application for assisting a used car shopper in verifying a vehicle's identity, including year, make, and model, so as to avoid a fraudulent purchase.

2. Description of the Related Art

Automobiles may be sold as new or used. If new, then purchasers are generally not concerned about wear and tear of the vehicle or broken components because new vehicles are tested at the factory. However, after the new vehicle has been purchased by a buyer and driven for a certain amount of time and mileage, various components of the vehicle may develop wear and tear thereby degrading the performance and reliability of the vehicle. Once the vehicle has been driven, purchasers become concerned that the vehicle may contain hidden defects which may not be readily noticeable.

Another concern associated with purchasing a used vehicle is that the used vehicle may be stolen or may be tampered with to hide negative information associated with the vehicle. For instance, some sellers may tamper with the vehicle identification number (VIN) to obtain a better history report for the vehicle, which in turn allows the seller to ask for a higher selling price.

The prior art has addressed the above-mentioned concerns of buyers through means which are generally expensive. For example, the buyer may have an automobile mechanic inspect the major and minor components of the vehicle to be purchased, which may require repair upon purchase of the vehicle. Furthermore, the inspection may also entail confirming that the vehicle actually matches the VIN. However, an inspection of the vehicle by the mechanic may be too expensive in view of the overall cost of the vehicle. Accordingly, except for highly priced vehicles, a mechanic typically does not pre-inspect vehicles for buyers prior to purchase of the vehicle.

Another method by which the buyer may address the concerns regarding the vehicle is to access public records obtained from the Department of Motor Vehicles (DMV). In particular, the public records of the DMV may contain information such as the year, make and model of the vehicle, the number of previous owners, or the like. This information is fairly inexpensive to obtain; however, the information may be unreliable or not particularly relevant based on a view that the DMV records generally relate to information which may be months to years old. Furthermore, obtaining such information may be an extremely tedious and time consuming process.

In view of the foregoing, there is a need in the art for an efficient means by which a used car shopper may obtain information pertaining to the vehicle under consideration, such as information to verify the identity of the vehicle, as well as information pertaining to the health of the vehicle.

As described below, the present invention addresses these and other improvements to contemporary vehicle authentication and diagnostic prediction systems.

### BRIEF SUMMARY OF THE INVENTION

There is provided a system for verifying a vehicle for sale on a smart phone, wherein the smart phone is capable of capturing an image of a vehicle identification number (VIN) of the vehicle for sale. The system comprises a verification and repair estimate module including a VIN decoder capable of matching a VIN with characteristic data of a vehicle associated with the VIN, wherein the characteristic data includes the vehicle year, make, and model. The verification and repair estimate module further includes a defect database in operative communication with the VIN decoder. The defect database includes information related to defects that have occurred in different vehicles and the reference mileage at which such defects occurred. A defect predictor is in communication with the VIN decoder and the defect database and is configured to identify defects in vehicles having similar characteristic data to the vehicle associated with the VIN. The system further includes a computer readable medium downloadable onto the smart phone for configuring the smart phone to communicate a first signal to the verification and repair estimate module, wherein the first signal includes information corresponding to the captured image of the VIN. The computer readable medium further configures the smart phone to receive a second signal from the verification and repair module including the characteristic data of the vehicle associated with the VIN communicated in the first signal, and the defects identified by the defect predictor. The smart phone is further configured by the computer readable medium to display the characteristic data and defects received in the second signal.

In another embodiment, the system utilizes the vehicle's license plate to verify the vehicle and conduct a diagnostic prediction. In such an embodiment, the system includes a verification and repair estimate module including a license plate decoder capable of matching a license plate with characteristic data of a vehicle associated with the license plate, wherein the characteristic data includes the vehicle year, make, and model. The verification and repair estimate module also includes a defect database in operative communication with the license plate decoder. The defect database includes information related to defects that have occurred in different vehicles and the reference mileage at which such defects occurred. A defect predictor is in communication with the license plate decoder and the defect database and is configured to identify defects in vehicles having similar characteristic data to the vehicle associated with the license plate.

It is also contemplated that other embodiments of the system employ a diagnostic tool, such as a scan tool, or the like, to retrieve data from the onboard computer, which may be used to verify the vehicle and make a diagnostic prediction. The diagnostic tool may retrieve an electronic VIN from the onboard computer and upload the electronic VIN to a verification and diagnostic prediction module including a VIN decoder and a diagnostic predictor to determine at least the year, make and model of the vehicle, and defects associated with similar vehicles. The information from the verification and diagnostic prediction module may be communicated to a smart phone for display.

The present invention is best understood by reference to the following detailed description when read in conjunction with the accompanying drawings.

### BRIEF DESCRIPTION OF THE DRAWINGS

These as well as other features of the present invention will become more apparent upon reference to the drawings wherein:

FIG. 1 is a schematic overview of an embodiment of a smart phone based vehicle verification and predictive diagnostic system;

FIG. 2 is a schematic view of a smart phone application used to configure the smart phone;

FIG. 3 is a schematic view of one embodiment of a predictive diagnostic system;

FIG. 4 is a flow chart listing the steps of one embodiment of a predictive diagnostic method;

FIG. 5 is one embodiment of a preliminary diagnostic matrix;

FIG. 6 is one embodiment of a predictive diagnostic report;

FIG. 7A is a schematic view of adjusting a mileage bracket to identify defects within an adjusted mileage bracket; and

FIG. 7B is a schematic view of adjusting defects and identifying adjusted defects within a mileage bracket.

Common reference numerals are used throughout the drawings and detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

According to various aspects of the present invention, there is provided a system and method by which a user may verify a vehicle 12 on the user's smart phone 14 using vehicle characteristic data, such as the vehicle identification number (VIN) or license plate information. The vehicle verification may be particularly useful for a used car shopper to verify the vehicle under consideration. The verification process may be completed by taking a picture of the VIN 15, scanning the VIN barcode 17, or taking a picture of the license plate 19 and then uploading that information to a remote database. The information may be cross-referenced on the database to determine the year, make and model of the vehicle associated with that VIN 15 or license plate 19. In this regard, the present system may be used to match an electronic VIN, image VIN (picture of the VIN taken with smart phone), and/or a VIN derived from the vehicle license plate to verify the vehicle. Furthermore, the VIN and/or license plate information may be used to derive the year, make and model of the vehicle, which may be displayed to the user to allow the user to conduct a visual confirmation. For instance, if the verification process results show that the vehicle is a 2005 TOYOTA™ CAMRY™, but the vehicle under consideration is a 2008 HONDA™ ACCORD™, that inconsistency may alert the user that the vehicle is not authentic, and that he may be a party to a fraudulent transaction.

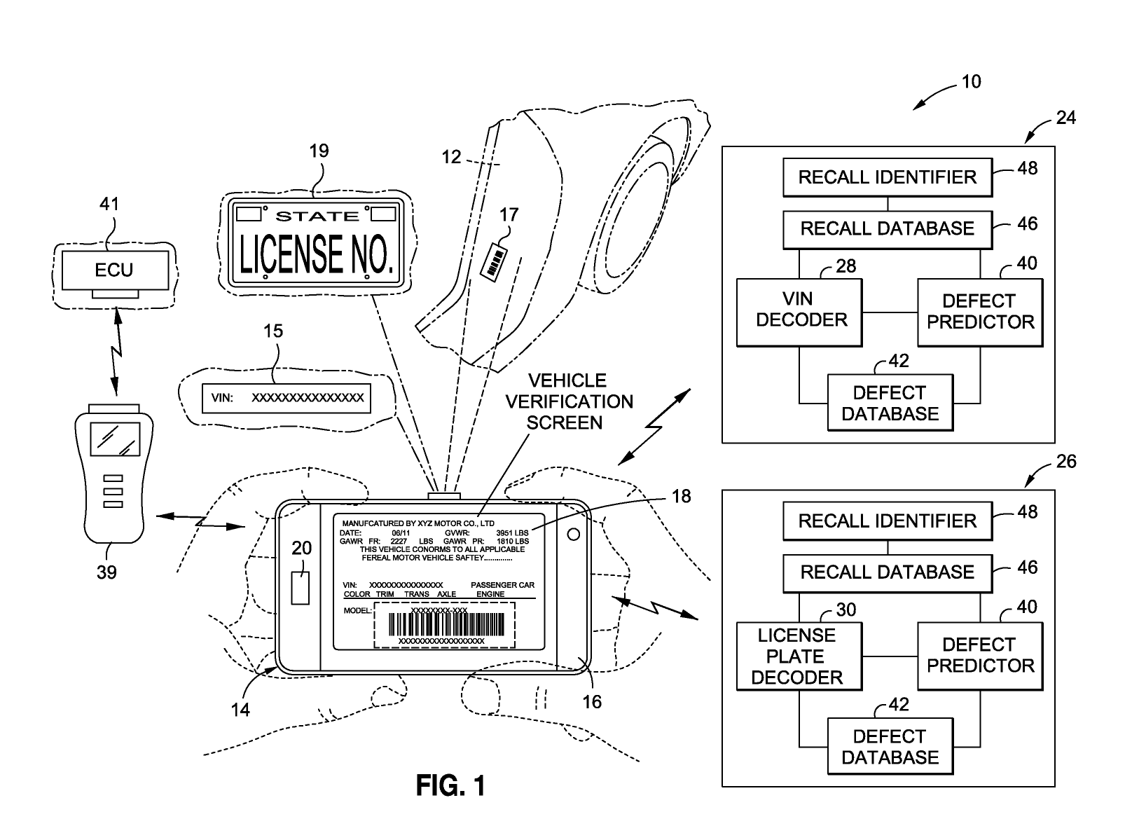

Referring now to FIG. 1, there is shown an exemplary embodiment of the vehicle verification system 10. The system 10 may utilize a smart phone application (“app”) which is downloaded on the smart phone 14 to configure the smart phone 14 to perform the retrieve, communication and display the information necessary to effectuate the verification process. The smart phone 14 depicted in FIG. 1 includes a housing 16, a touch screen display 18, and an input button 20. As used herein, a “smart phone” is a mobile phone built on a mobile computing platform, which typically includes more advance computing ability and conductivity then a standard mobile phone. Exemplary smart phones 14 include the iPhone™ by Apple™, the Droid™ by Motorola™, the Galaxy Nexus™ by Samsung™, and the Blackberry Curve™. It is also contemplated that the term “smart phone” may also include tablet computers such as the Apple iPad™, or other portable electronic devices, such as the iPod Touch™, PDAs, or other portable electric devices currently known or later developed by those skilled in the art.

The smart phone 14 further includes a camera 22 for capturing images of the vehicle 12 including vehicle characteristic data. The camera 22 may be integrated into the smart phone 14 and may be controlled via the input button 20 and/or the touch screen display 18. The camera 22 may be used to take a picture of the VIN number 15, the VIN bar-code 17 or the license plate 19 to capture the vehicle characteristic data. The smart phone 14 or a remote image decoder may include visual recognition software for identifying the VIN or license plate alphanumeric code from the image.

As shown in FIG. 1, the vehicle 12 may include vehicle characteristic data which identifies the particular vehicle. The vehicle characteristic data may be embodied in various physical forms and may be located in various locations of the vehicle 12. For instance, the vehicle characteristic data may include the VIN 15, which may be located on the dashboard under the windshield, or on the inside of the door jamb. The door jamb location may list the actual VIN, or a bar-code 17 representative of the VIN may be placed on the door jamb. The vehicle characteristic data may also include the license plate information (i.e., state and license plate number). The vehicle characteristic data is not limited to the VIN number 15 or license plate information 19, and those skilled in the art will appreciate that other data or characteristics known to identify a vehicle 12 may be used without departing from the spirit and scope of the present invention.

The system additionally includes a verification module which utilizes the vehicle characteristic data to identify the vehicle. FIG. 1 shows a first verification module 24 which utilizes a VIN number, and a second verification module 26 which utilizes license plate information. The first and second verification modules 24, 26 may be used separate from each other, or in combination with each other. The first verification module 24 includes a VIN decoder 28 which is capable of determining the year, make, and model of a vehicle associated with a particular VIN. The VIN decoder 28 may further be capable of determining the engine, color and other vehicle characteristics associated with the particular VIN.

The second verification module 26 includes a license plate decoder 30 which is capable of determining the year, make, and model of a vehicle associated with the particular license plate 19. The license plate decoder 30 may additionally be capable of determining the engine, color and other vehicle characteristics associated with the particular license plate 19.

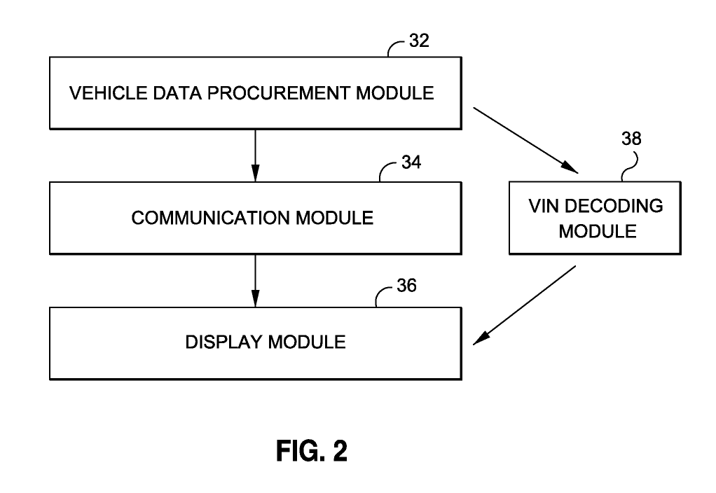

One embodiment of the smart phone app. is depicted schematically in FIG. 2. The smart phone app. includes a vehicle data procurement module 32, a communication module 34, and a display module 36. The procurement module 32 is capable of configuring the smart phone camera 22 to take a picture or scan of the VIN 15, VIN barcode 17, license plate 19, or other vehicle characteristic. The procurement module 32 is additionally capable of converting the captured image into a vehicle characteristic signal capable of being communicated by the smart phone 14 to a remote database, which may include the first or second verification modules 24, 26.

The communication module 34 is in operative communication with the procurement module 32 and is capable of effectuating communication of the vehicle characteristic signal from the smart phone 14 to the remote database. In this regard, the communication module 34 may determine the communication capabilities/protocols of the smart phone 14 to determine how the signal should be communicated. For instance, the signal may be communicated via long range communication means, such as a wireless cellular network, or via short range communication means, such as Bluetooth™, WiFi, 802.11, or the like.

The communication module 34 is also capable of receiving a verification signal from the remote location, wherein the verification signal includes information related to the true characteristics associated with the vehicle characteristic data. In this regard, the information included in the verification signal may relate to the year, make, model, engine, color, etc. of the vehicle under consideration.

The display module 36 is in communication with the procurement module 32 and the communication module 34 and is capable of displaying information related to the verification process. The display module 36 may be capable of displaying the picture taken by the camera 22 to allow the user to verify that the correct image was captured. In this regard, the display module 36 may be capable of operating the display 18 on the smart phone 14. The display module 36 may also be configured to display an image corresponding the verification signal, such as the year, make, and model of the vehicle.

It is additionally contemplated that various embodiments of the smart phone app. may include a VIN decoding module 38 capable of decoding the VIN locally on the smart phone 14, rather than having the decoding performed at a remote location. The VIN decoding module 38 is in communication with the procurement module 32 to receive the vehicle characteristic signal therefrom, and the display module 36 so as to allow for display of the VIN decoding results.

It is understood that various aspects of the present invention will equip used car shoppers with useful information related to a vehicle under consideration for purchase. In particular, the used car shopper may be able to verify that the vehicle is authentic and true to what is being represented about the vehicle. If the vehicle VIN or license plate has been tampered with, as may be the case when the title to the vehicle is not clean, the information presented to the used car shopper allows the used car shopper to easily confirm the true nature of the vehicle.

Furthermore, another beneficial feature of certain implementations of the present invention is the ease-of-use in operating the smart phone app. The verification information may be obtained by the used car shopper with minimal user input or navigation of a user interface. According to one embodiment, the user may be required to focus the camera 22 on the portion of the vehicle 12 including the VIN or license plate, and then snap the picture. Once the picture is captured, the information may be automatically uploaded to the remote location (or, in some instances, locally for local VIN decoding) for decoding of the VIN or license plate. The verification is received by the smart phone 14 and the verification results displayed on the smart phone display 18 without any input or navigation by the user.

It is contemplated that the minimal amount of user input required to perform the above-described process may be facilitated through touch-screen input, keypad entry, voice-command, virtual hand gestures, or other smart phone inputs known by those skilled in the art.

Furthermore, although the foregoing contemplates capturing the VIN or license plate via the smart phone camera 22, it is understood that the smart phone app. will include an option to allow the user to manually enter the VIN or license plate number. Thus, if the smart phone camera 22 is broken, or if the phone 14 does not include a camera 22, the app. may continue to function as a vehicle verification means.

Although the foregoing describes capturing the vehicle characteristic data (i.e., VIN or license plate info) via the smart phone camera 22, it is also contemplated that other embodiments may utilize a diagnostic tool 39 to retrieve vehicle characteristic data from the onboard vehicle computer 41. For instance, the diagnostic tool 39 may be plug connectable or wirelessly connectable to the onboard computer 41 during a test-drive of the vehicle to retrieve information from the onboard computer 41. The diagnostic tool 39 may retrieve an electronic VIN or similar vehicle characteristic data from the onboard computer 41.

The information retrieved by the diagnostic tool 39 may be uploaded to the first verification module 24 to decode the VIN with the VIN decoder 28. The diagnostic tool 39 may include a short range communication circuit which allows for short range communication between the diagnostic tool 29 and the smart phone 14. Thus, the diagnostic tool 39 may upload the retrieved information to the smart phone 14, which in turn, uploads the information to the VIN decoder 28. In this embodiment, the vehicle data procurement module 32 and the communication module 34 of the smart phone app. facilitate receipt of the information from the diagnostic tool 39, and subsequent upload of the information to the VIN decoder 28. The results from the VIN decoder 28 may be communicated back to the smart phone 14 for display on the smart phone display 18.

The electronic VIN retrieved by the diagnostic tool 39 may be compared with the VIN captured from the smart phone camera, or the VIN derived from the license plate, to verify that no one has tampered with the VIN. This comparison may be done automatically (i.e., with minimal or no user input) once at least two VINs are retrieved/derived. The results of the comparison may be communicated to the smart phone for display to the user. In this regard, a positive verification signal may be communicated if the VINs match, while a negative verification signal may be communicated if the VINs do not match.

As noted above, the smart phone app. configures the smart phone 14 to serve as a tool for acquiring the VIN or license plate information (such as via the smart phone camera 22 or diagnostic tool 39), and as a tool for communicating that information to a remote location. Although a primary purpose of the smart phone app. may be to verify the vehicle 12, it is contemplated that once VIN or license plate is decoded, additional information which may be useful to the used car shopper may be easily obtained. For instance, in one embodiment, the decoded VIN or license plate information may be used to make a diagnostic prediction of the vehicle under consideration by the used car shopper. More specifically, the diagnostic predication may include a summary of likely failures or repairs for the vehicle under consideration, and the mileage at which those failures or repairs will likely occur. Thus, the predictive diagnostic feature may provide the used car shopper with an estimate as to the health of the vehicle and the cost for operating and maintaining the vehicle in the future.

The diagnostic prediction feature includes a defect predictor 40 which compares the vehicle characteristic data (i.e., the determined year, make, model, etc.) associated with a vehicle under consideration with information in a historical defect database 42 to make the diagnostic prediction. The diagnostic prediction may be summarized as being a LOW, MEDIUM or HIGH probability of failure, and may relate to the vehicle as a whole, or a particular component, within a certain mileage range. The defect predictor 40 and defect database 42 may be implemented into the first and second verification modules 24, 26, as shown in FIG. 1.

The defect database 42 includes a comprehensive compilation of historical vehicle data. Each entry in the database 42 relates to a system or component failure for a specific vehicle associated with characteristic data representative of the vehicle. For instance, the characteristic data may include the year, make, model and engine of the vehicle, the vehicle VIN, and/or the vehicle license plate. Therefore, to determine the predictive diagnosis for the vehicle under consideration, the defect predictor 40 matches the characteristic data associated the vehicle under consideration (i.e., the results from the VIN decoder 28 or license plate decoder 30) with vehicle data in the database 42 associated with similar characteristic data to determine the likelihood of failure within a certain mileage range.

The failures/defects listed in the historical defect database 42 may be identified according to several different strategies. In one embodiment, the defects are associated with actual repairs performed at a repair shop, while in other embodiments, the defects are determined by insurance claims submitted to an insurance company. In yet another embodiment, the defects are determined based on a probabilistic determination of a likely defect based on an analysis of vehicle data. For more information related to the probabilistic determination, please see U.S. patent Ser. No. 13/567,745 and U.S. Pat. No. 8,019,503 issued on Sep. 13, 2011, and also assigned to Applicant. The failures/defects listed in the database 42 may also be determined according to a combination of any of the strategies listed above, or according to other means known by those skilled in the art.

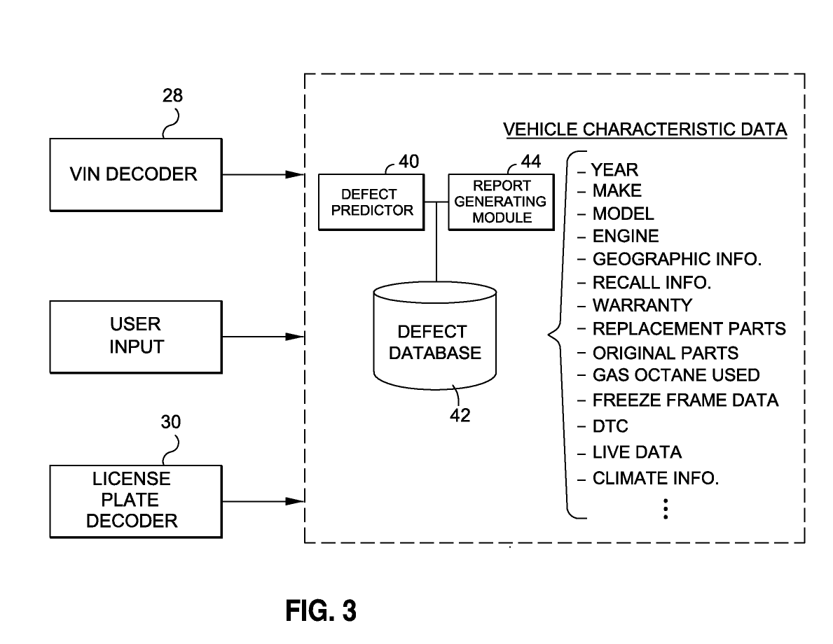

The diagnostic prediction feature is further illustrated in FIG. 3, and may additionally include a report generating module 44 in operative communication with the defect predictor 40 and the defect database 42. The report generating module 44 is operative to compile the results and generate the predictive diagnostic report, which is presented to the user on the smart phone display 18.

The following example illustrates benefits which the predictive diagnostic feature provides. In this example, the vehicle under consideration is a 2005 HONDA™ ACCORD™ although it is understood that the predictive diagnostic system may be used with any vehicle. The defect database 42 includes several entries related to a 2005 HONDA™ ACCORD™. Based on those entries, a used car shopper considering a 2005 HONDA ACCORD can determine the likelihood that the specific vehicle under consideration will experiences problems at certain mileage ranges. For example, between 75,000 and 100,000 miles, there may be a high likelihood that the vehicle will need replacing of the ignition coil, a median probability or likelihood that the vehicle will need replacement of the camshaft position sensors, and a low probability that the vehicle will replacement of the engine coil module.

According to one embodiment, the input into the defect database 42 is vehicle characteristic data representative of the vehicle under consideration. Thus, the more vehicle characteristic data entered into the defect database, the more accurate and precise the resultant predictive diagnosis will be. Along these lines, the vehicle characteristic data utilized in the defect prediction analysis may not only include year, make, model, and engine, as mentioned above in connection with VIN or license plate decoding, but may also include other information that is specific to the vehicle under consideration. Therefore, the user may have the option of entering additional information pertaining to the vehicle under consideration. For instance, the additional vehicle characteristic data may include the geographic area (state, city, zip code, etc.) or climatic conditions in which the vehicle is primarily driven. Vehicles in different geographic areas may encounter symptoms related to the geographic area in which the vehicle is driven. Those skilled in the art will readily appreciate that vehicles driven in the northern part of the United States regularly encounter snow in the winter months. Road maintenance crews in those areas of the country regularly spread salt on the roads to mitigate slippery road conditions. Thus, as the vehicle drives over the salted roads, the undercarriage of the vehicle may be exposed to the salt, which may cause rust/corrosion or may lead to other problematic conditions.

However, vehicles driven in southern states may not be susceptible to the same problems since those vehicles are generally not driven over salted roads. Other geographic locations offer different environmental conditions which may be problematic for the vehicle, i.e., desert areas may lead to engine overheating. Therefore, the geographic location in which the vehicle under consideration is driven may lead to a more accurate and precise predictive diagnosis. Exemplary components/devices which may be climatically or geographically sensitive include may include the vehicle's muffler, body panel (susceptible to rust), radiator, battery, door lock, and starter.

Other vehicle characteristic data which may be entered into the historical database 42 is recall information, usage information (i.e., how many miles the vehicle is driven per year), warranty information, replacement parts on the vehicle, original parts on the vehicle, gas octane used, maintenance records. Thus, the vehicle characteristic data entered into the defect database 42 allows the user to obtain matches with vehicle records associated with vehicles that not only are the same or similar to the vehicle under consideration, but were also operated and maintained in a similar fashion. In some cases, the used car shopper may have to obtain that information directly from the seller, although in some cases, that information may be readily available on a sales sheet or flyer.

According to one embodiment, after the vehicle characteristic data is entered into the defect database 42, a preliminary diagnostic matrix will be generated which shows the predicted components/systems that are likely to fail along one axis, and several mileage brackets along another axis. The body of the matrix is filled with the number of failures associated with the respective components/systems occurring in each mileage bracket for the respective components.

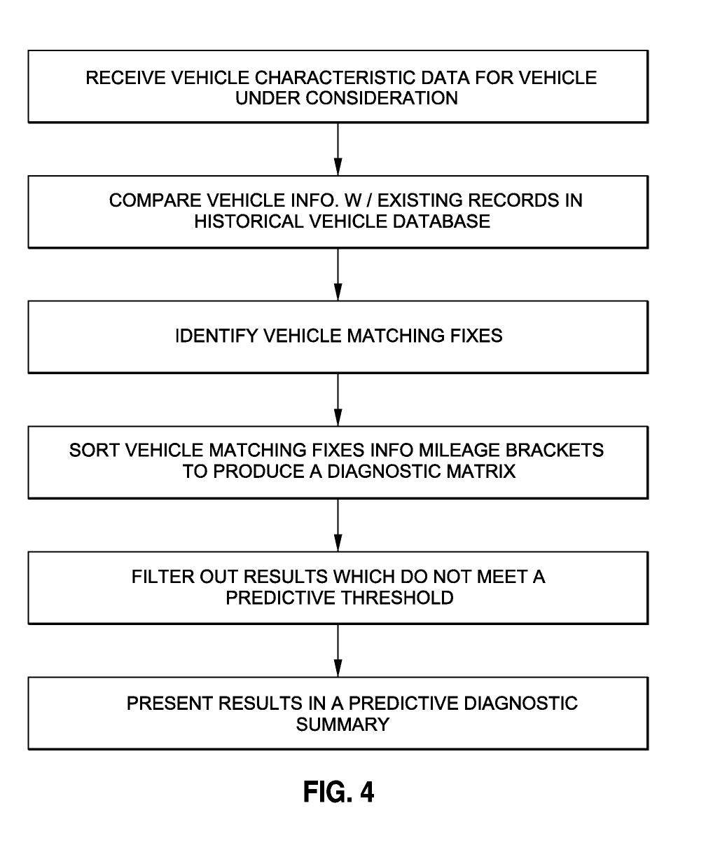

The number of failures may then be totaled for each component within each mileage bracket to determine a percentage of failure. For instance, as shown in the example depicted in FIG. 4, there was only 1 failure within the 0-5,000 mile bracket, with that sole failure being attributable to Component 4. Thus, Component 4 comprises 100% of the failures in the 0-5,000 mileage bracket. In the 5,000-10,000 mileage bracket, there were 5 total failures, with one being attributable to Component 2, one being attributable to Component 3, two being attributable to Component 4 and one being attributable to Component 5. Thus, Component 2 comprises 20% of the failures, Component 3 comprises 20% of the failures, Component 4 comprises 40% of the failures and Component 5 comprises 20% of the failures. This totaling process is completed to determine the percentage of failure for the components failing in each mileage bracket.

In one implementation, the predictive diagnostic feature may filter out results which do not meet or exceed a defined threshold. In this regard, it is desirable to only report failures which are believed to be representative of a pattern and thus indicative of a probable outcome in the future. If there are only a minimum number of failures, i.e., failures below the set threshold, such a minimum number of failures may not be a reliable data-set for representing a potential failure in the future. The threshold may be selectively adjusted by the system operator, or by the user. The threshold may be low for newer vehicles, since there is generally less data associated with the new vehicles, and high for older vehicles, since there is generally more data associated with the older vehicles.

Referring again to FIG. 4, a threshold of two (2) may be set to filter out all failures that only occur once. Therefore, applying the threshold to the matrix 30, there are no failures that satisfy the threshold in the 0-5,000 mile bracket, only two failures (Component 4) that satisfy the threshold in the 5,000-10,000 mile bracket, three failures (Component 1) that satisfy the threshold in the 10,000-15,000 mile bracket, five failures (Components 2 and 4) that satisfy the threshold in the 15,000-20,000 mile bracket, seven failures (Components 1 and 4) that satisfy the threshold in the 20,000-25,000 mile bracket, and sixteen failures (Components 1, 2, and 4) in the 25,000-30,000 mile bracket.

The matrix may further be beneficial to identify clusters of failures at certain mileage points. For instance, with regard to Component 1 listed in the example matrix, there are three failures between 10,000-15,000 miles and five failures between 20,000-25,000 miles, although there are zero failures in the intermediate mileage bracket (i.e., 15,000-20,000 miles).

After the thresholds have been applied, the overall percentages may be recalculated to determine the percentage of failures within each mileage bracket that meet the threshold.

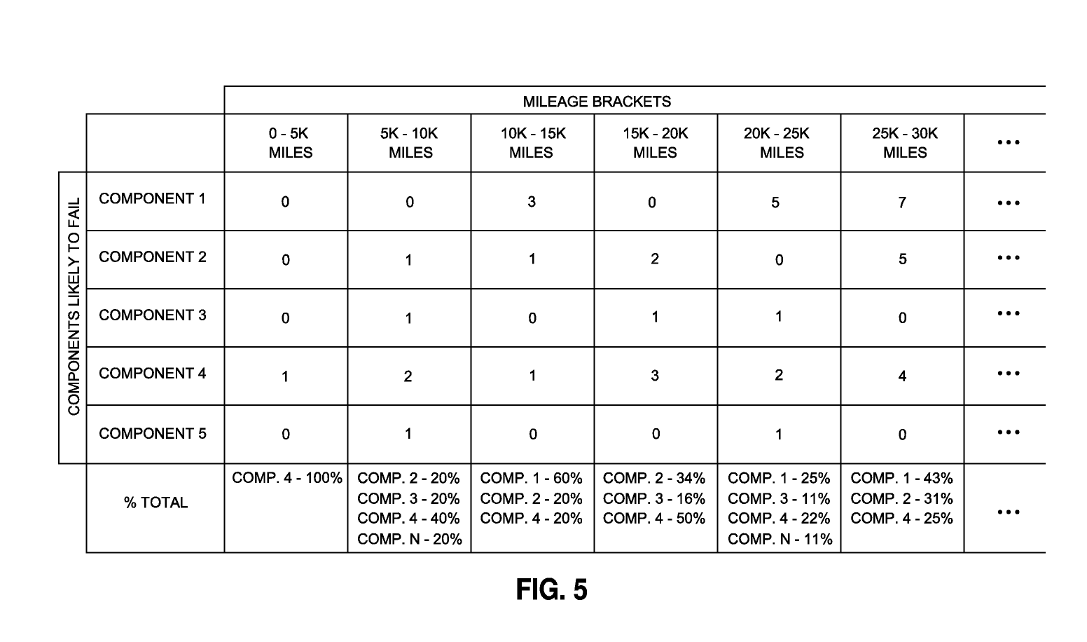

The results may be presented to the user in a user friendly summary. FIG. 5 shows an exemplary predictive diagnostic summary which displays each component and the likelihood of failure associated with each component. The likelihood of failure is represented as either being LOW, MEDIUM, or HIGH. A LOW likelihood of failure may be associated with 0-30% chance of failure, a MEDIUM likelihood of failure may be associated with 30%-60% chance of failure, while a HIGH likelihood of failure may be associated with a 60%-100% chance of failure. It is also contemplated that the probability of failure may be presented in numerical terms, i.e., the actual likelihood of failure percentage associated with that component. The chances of failure listed above with each likelihood of failure are exemplary in nature only and are not intended to limit the scope of the present invention.

In one embodiment, the predictive diagnostic feature may also be capable of looking up prices, repair shops, and/or repair procedures for fixing/replacing the components listed in the predictive diagnostic summary.

According to other implementation of the present invention, the predictive failure analysis may also be refined based on specific diagnostic history of the vehicle under consideration. In other words, the predictive failure analysis may be able to correlate one part failing in response to another part failing in the past. More specifically, one part or component which wears out may have a cascading effect on wearing out other parts or components, particularly other parts or components within the same vehicle system. Thus, there may be a system level correlation when one part has failed in the past.

The predictive diagnostic feature may also be capable of adjusting the predictive diagnosis for the vehicle under consideration based on information received from the vehicle, such as live data. The live data may be obtained during a test drive of the vehicle under consideration. The predictive diagnostic feature may generate a baseline predictive diagnostic summary when characteristic data is uploaded to the historical database 42, as described above. From the baseline predictive diagnostic summary, the system may be able to make a prediction as to the general health or remaining effectiveness/lifespan of one or more vehicle components. For instance, the baseline predictive diagnostic summary may used to predict that a particular component may be useful for another 5,000 miles before the likelihood of failure increases to the point where a failure is likely.

The information extrapolated from the baseline predictive diagnostic summary may be cross-referenced with live data to provide a more accurate prediction as to the remaining lifespan of that component. For instance, if the live data shows a relatively healthy component, the prediction of 5,000 miles before a likely failure may be increased. Conversely, if the live data shows a relatively worn or ineffective component, the prediction of 5,000 miles before a likely failure may be decreased.

Thus, the predictive diagnostic feature may conduct an iterative analysis based on the live data to more accurately predict the likelihood of failure. The iterations include initially generating the baseline diagnostic report from basic characteristic data, i.e., year, make, model. Then the prediction may be refined based on the live data supplied to the predictive diagnostic feature. In this regard, the likelihood of failure may be increased, decreased, or remain unchanged based on the live data.

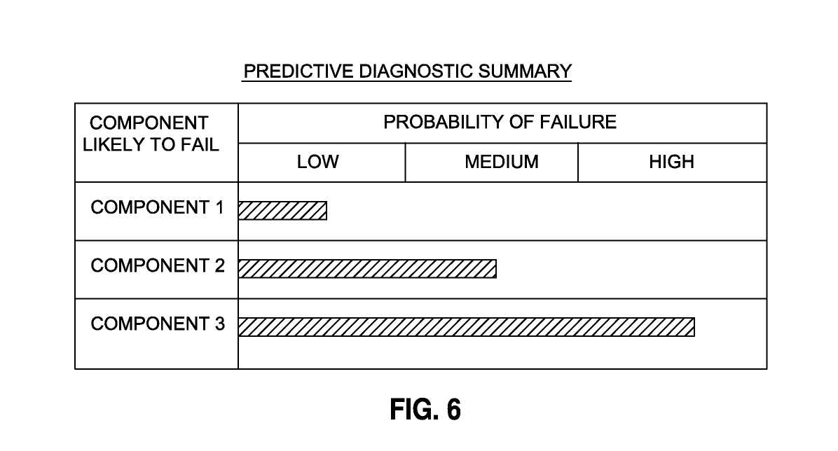

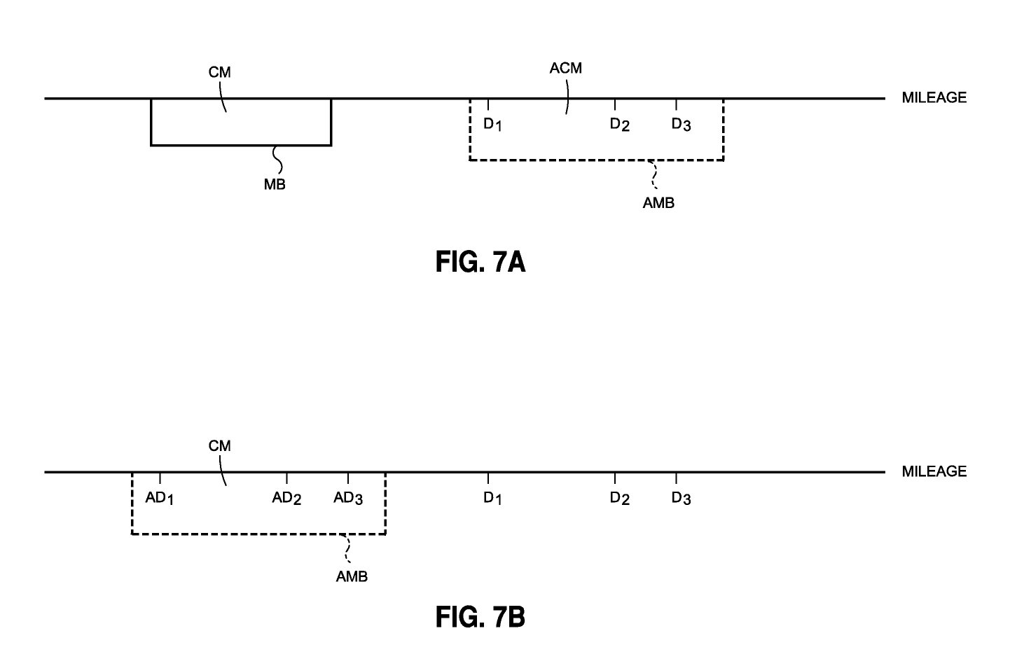

Referring now specifically to FIGS. 6A, there is shown a schematic view of an adjustment made based on information received from the vehicle. In FIG. 6A, the current mileage “CM” of the vehicle under consideration is identified on a mileage axis. A mileage bracket “MB” is defined along the mileage axis, wherein the mileage bracket MB includes the current mileage CM. The mileage bracket MB may extend from a mileage less than the current mileage CM to a mileage more than the current mileage CM. For instance, the mileage bracket MB may extend for 10,000 miles, and extend from 2,500 miles less than the current mileage CM, to 7,500 more than the current mileage CM. Those skilled in the art will readily appreciate that the upper and lower bounds to the mileage bracket MB may be selectively adjusted as desired by the user.

After vehicle information is analyzed, the current mileage “CM” may be adjusted to define an adjusted current mileage “ACM.” For instance, if the vehicle was driven off-road, in harsh conditions, etc., the vehicle may have endured “hard miles.” Thus, the current mileage CM for the vehicle may be increased to account for the hard miles. Conversely, if the vehicle was almost exclusively driven in ideal driving conditions, and has been routinely maintained, the current mileage CM of the vehicle may be decreased to account for the optimal conditions. In the example listed in FIG. 6A, the current mileage CM has been increased to define an adjusted current mileage ACM that is greater than the current mileage.

Once the adjusted current mileage ACM has been determined, an adjusted mileage bracket “AMB” is defined based on the adjusted current mileage ACM. The defects which fall within the adjusted mileage bracket AMB are then identified. In FIG. 6A, the defects falling within the adjusted mileage bracket AMB include defects D1, D2, and D3.

In the example described above in relation to FIG. 6A, the current mileage is adjusted to define an adjusted current mileage to determine the defects associated with the vehicle. In FIG. 6B, the mileage associated with the defects is adjusted based on the information received from the vehicle. In other words, the information received from the vehicle may make it more likely that defects will occur sooner (i.e., after fewer miles) or later (i.e., after more miles).

After a preliminary assessment, the current mileage CM and defects D1, D2, D3 may be plotted on the mileage axis. A more detailed analysis may reveal that the effective life of the vehicle is less than the standard or more than the standard. Therefore, the mileage associated with the defects may be adjusted along the mileage axis, accordingly. When the effective life of the vehicle is more than the standard, the mileage associated with the defects may be increased, and conversely, if the effective life of the vehicle is less than the standard, the mileage associated with the defects may be decreased.

After this analysis, an adjusted mileage bracket AMB may be created to include the current mileage CM of the vehicle. The adjusted defects AD1, AD2, and AD3 which fall within the adjusted mileage bracket AMB may then be identified.

It is understood that all summaries, reports or other information generated during the verification and/or predictive diagnostic processes may be displayed on the smart phone display 18. However, it is understood that the user may utilize a separate display, such as a computer screen or the like to view the information on an enlarged screen.

In addition to using the decoded VIN or license plate information for purposes of conducting a predictive diagnostics analysis, other implementations of the present invention relate to obtaining other information which may be useful to a used car shopper. In one embodiment, the decoded VIN or license plate information is used to determine recall information for the vehicle under consideration. FIG. 1 shows a recall database 46 in communication with the VIN decoder 28 and the license plate decoder 30. A recall identifier 48 is in communication with the recall database 46 to identify recalls in the vehicle under consideration.

The recall database 46 may include recall information classified by vehicle year, make, model, and/or more detailed vehicle classification information, such as engine type, vehicle trim, etc. The recall identifier 48 is configured to match the vehicle classification information with recalls in the recall database 46 associated with the vehicle classification information. The identified recalls are communicated back to the user's smart phone 14 for display on the smart phone display 18.

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. A system for verifying a used vehicle for sale on a smart phone capable of capturing an image of a vehicle identification number (VIN) of the vehicle for sale, the system comprising:
a remote verification and repair estimate module including:
a VIN decoder capable of matching a VIN with characteristic data of a vehicle associated with the VIN, the characteristic data including the vehicle year, make, and model;
a defect database having information related to defects that have occurred in different vehicles and the reference mileage at which such defects occurred; and
a defect predictor in communication with the VIN decoder and the defect database and configured to identify defects listed in the defect database corresponding to vehicles having similar characteristic data to the vehicle associated with the VIN; and
a computer readable medium downloadable onto the smart phone for configuring the smart phone to:
communicate a first signal to the remote verification and repair estimate module, the first signal including information corresponding to the captured image of the VIN;
receive a second signal from the remote verification and repair module including the characteristic data of the vehicle associated with the VIN communicated in the first signal, and the defects identified by the defect predictor; and
displaying the characteristic data and defects received in the second signal.

2. The system recited in claim 1, wherein the characteristic data further includes the engine and color of the vehicle associated with the VIN.

3. The system recited in claim 1, wherein the remote verification and repair estimate module further includes a recall identifier in communication with the VIN decoder to receive at least one of the VIN or characteristic data therefrom, the recall identifier being configured to determine recall information associated with the at least one of the VIN or characteristic data.

4. The system recited in claim 3, wherein the second signal from the remote verification and repair module includes recall information identified by the recall identifier.

5. The system recited in claim 1, wherein the defect database includes the reference mileage associated with each identified associated defect.

6. The system recited in claim 5, wherein the computer readable medium is further configured to prompt the user to enter the mileage of the vehicle.

7. The system recited in claim 6, wherein the mileage is communicated to the verification and defect module in the first signal, the defect predictor further being configured to restrict the identified defects to defects that have occurred within a mileage bracket that substantially corresponds to the current mileage communicated in the first signal.

8. The method as recited in claim 7, further including the step of receiving live data from the vehicle under consideration, the live data including diagnostic information regarding operating characteristics of an automotive device associated with at least one defect within the mileage bracket.

9. The method as recited in claim 8, further including the step of adjusting the current mileage based on diagnostic information indicating the operating condition of the automotive device associated with the defect.

10. A system for verifying a used vehicle for sale on a smart phone capable of capturing an image of a vehicle license plate of the vehicle for sale, the system comprising:
a verification and repair estimate module including:
a license plate decoder capable of matching a license plate with characteristic data of a vehicle associated with the license plate, the characteristic data including the vehicle year, make, and model;
a defect database having information related to defects that have occurred in different vehicles and the reference mileage at which such defects occurred; and
a defect predictor in communication with the license plate decoder and the defect database and configured to identify defects listed in the defect database corresponding to vehicles having similar characteristic data to the vehicle associated with the license plate; and
a computer readable medium downloadable onto the smart phone for configuring the smart phone to:
communicate a first signal to the verification and repair estimate module, the first signal including information corresponding to the captured image of the license plate;
receive a second signal from the verification and repair module including the characteristic data of the vehicle associated with the license plate communicated in the first signal, and the defects identified by the defect predictor; and
displaying the characteristic data and defects received in the second signal.

11. The system recited in claim 10, wherein the characteristic data further includes the engine and color of the vehicle associated with the license plate.

12. The system recited in claim 10, wherein the license plate decoder is further configured to identify a registered owner of the vehicle associated with the license plate.

13. The system recited in claim 10, wherein the defect database includes the reference mileage associated with each identified associated defect.

14. The system recited in claim 13, wherein the computer readable medium is further configured to prompt the user to enter the mileage of the vehicle.

15. The system recited in claim 14, wherein the mileage is communicated to the verification and defect module in the first signal, the defect predictor further being configured to restrict the identified defects to defects that have occurred within a mileage bracket that substantially corresponds to the current mileage communicated in the first signal.

16. The system recited in claim 10, wherein the defects in the defect database are derived from actual repair records.

17. The system recited in claim 10, wherein the defects in the defect database are derived from a probabilistic determination of a most likely defect based on vehicle diagnostic data.

18. A system for using a smart phone to verify vehicle characteristics of a used vehicle having an onboard computer, the smart phone being configured to capture an image of the vehicle identification number (VIN), the system comprising:
a diagnostic tool connectable with vehicle's onboard computer and configured to retrieve an electronic vehicle identification number (VIN) from the onboard computer; and
a computer readable medium downloadable onto the smart phone for configuring the smart phone to:
establish communication with the diagnostic tool to receive the electronic VIN therefrom;
identify the VIN in an image captured by the smart phone;
compare the electronic VIN with the VIN in the image; and
communicate a positive verification signal when the electronic VIN matches the VIN in the image, and communicate a negative verification signal when the electronic VIN does not mage the VIN in the image.

19. The system recited in claim 18, further comprising:
a VIN decoder in operative communication with the diagnostic tool, the VIN decoder being configured to decode the electronic VIN to determine vehicle characteristic data, including the vehicle year, make, and model;
a defect database in operative communication with the VIN decoder, the defect database having information related to defects that have occurred in different vehicles and the reference mileage at which such defects occurred; and
a defect predictor in communication with the VIN decoder and the defect database and configured to identify defects in vehicles having similar characteristic data to the vehicle associated with the VIN.

20. The system recited in claim 19, wherein the computer readable medium further configures the smart phone to display the vehicle characteristic data identified by the VIN.

21. The system recited in claim 18, further comprising a license plate decoder in operative communication with the smart phone, the license plate decoder being configured to decode a license plate to determine the vehicle year, make and model, wherein:
the smart phone is configured to capture an image of a license plate associated with the used vehicle,
the computer readable medium configures the smart phone to communicate a signal corresponding to the captured image to the license plate decoder;
the license plate decoder is in operative communication with the smart phone to receive the signal therefrom and decode the license plate to determine the vehicle year, make, and model.

22. The system recited in claim 21, wherein
the smart phone is configured to communicate a signal corresponding to the captured image of the VIN to the VIN decoder;
the VIN decoder is in operative communication with the smart phone to receive the signal therefrom and decode the VIN to determine the vehicle year, make, and model;
the VIN decoder and license plate decoder being configured to compare the results from the decoded electronic VIN from the diagnostic tool with the results from the decoded VIN from the smart phone with the results from the decoded license plate to determine whether the electronic VIN matches the VIN from the smart phone and the license plate.

23. A system for verifying vehicle characteristics of a used vehicle, the system comprising:
a smart phone capable of capturing a first image of a VIN associated with the used vehicle and a second image of a license plate associated with the used vehicle;
a license plate decoder in operative communication with the smart phone, the license plate decoder being configured to decode a license plate to determine the vehicle year, make and model; and
a VIN decoder is in operative communication with the smart phone to receive the signal therefrom and decode the VIN to determine the vehicle year, make, and model;
the VIN decoder and license plate decoder being configured to compare the results from the decoded VIN with the results from the decoded license plate to determine whether the VIN matches the license plate.
